(19) United States
(12) Patent Application Publication
(10) Pub. No.: US 2022/0328817 A1
(43) Pub. Date: Oct. 13, 2022

(54) SOLID-STATE LITHIUM-ION CONDUCTOR MATERIALS, POWDER MADE OF SOLID-STATE ION CONDUCTOR MATERIALS, AND METHOD FOR PRODUCING SAME

(71) Applicant: SCHOTT AG, Mainz (DE)

(72) Inventors: Jörg Schuhmacher, Kornwestheim (DE); Philipp Treis, St. Aldegund (DE); Jochen Drewke, Bechtolsheim (DE); Hans-Joachim Schmitt, Ockenheim (DE); Rolf Samsinger, Rüsselsheim a. M. (DE); Andreas Roters, Mainz (DE); Meike Schneider, Taunusstein (DE)

(73) Assignee: SCHOTT AG, Mainz (DE)

(21) Appl. No.: 17/847,903

(22) Filed: Jun. 23, 2022

Related U.S. Application Data
(63) Continuation of application No. PCT/EP2020/078726, filed on Oct. 13, 2020.

(30) Foreign Application Priority Data
Dec. 23, 2019 (DE) 10 2019 135 702.0

(51) Int. Cl. H01M 4/485; H01M 4/48; H01M 4/58; H01M 10/0525; H01M 10/0562; C01D 15/02; C01G 33/00; C01B 25/45

(52) U.S. Cl. CPC H01M 4/485; H01M 4/48; H01M 4/5825; H01M 10/0525; H01M 10/0562; C01D 15/02; C01G 33/006; C01B 25/45; H01M 2004/021

(57) ABSTRACT

A powder with particulates of a lithium ion-conducting material has a conductivity of at least 10⁻⁵ S/cm. The powder has an inorganic carbon content (Total Inorganic Carbon Content (TIC)) of less than 0.4 wt % and/or an organic carbon content (Total Organic Carbon Content (TOC)) of less than 0.1 wt %. The particulates have a d50 particle size in a range from 0.05 μm to 10 μm. The particulates have a particle size distribution log (d90/d10) of less than 4.

### CROSS-REFERENCE TO RELATED APPLICATIONS

This application is a continuation International Patent Application No. PCT/EP2020/078726, filed on Oct. 13, 2020, which claims priority to German Patent Application DE102019135702.0, filed on Dec. 23, 2019, each of which is incorporated by reference herein in its entirety.

### BACKGROUND

### 1. Field of the Disclosure

The present disclosure relates to a powder with particulates composed of lithium ion-conducting material, to lithium-ion conductors comprising the powder, and to methods for producing same. The disclosure also relates to the use of the lithium-ion conductors of the disclosure, more particularly in separators, anodes, cathodes, primary batteries, and secondary cells. The disclosure relates more particularly to solid-state ion conductors for use in batteries, more particularly in lithium batteries, and to a method for producing them.

### 2. Description of Related Art

Solid-state lithium-ion conductors are attracting increasing interest since they allow the replacement of liquid electrolytes, which frequently pose a fire hazard or are toxic, and hence allow the safety of lithium-based batteries to be improved.

Integration into the battery takes place in general in powder form, with the solid-state conductor being either mixed with other battery components, such as active materials or polymers, for example, and optionally sintered, or sintered or pressed with further additions. In such cases, however, there are often high contact resistances, or only low conductivities are attained in the sintered components.

In the case of the sintering of such powder materials to form ceramic battery components, such as to form separator membranes, for example, or in connection of storage materials and other constituents to form cathode composites, moreover, it should additionally be borne in mind that this operating step under certain circumstances must take place under a reducing atmosphere. For example, output conductors consisting of elemental copper would be severely damaged by oxidation if the ceramic processing were to take place in air or in oxygen, and would consequently lose their function.

These problems can be solved by the materials described in the present disclosure.

A disadvantage of solid-state lithium-ion conductors in practical use is that as early as during their production they react with the moisture and the carbon dioxide in the air, leading to the formation of lithium hydroxide and, in a process occurring in parallel, or downstream, to formation of lithium carbonate on the surface. This process is described for example for lithium garnets in Duan et al., Solid State Ionics (2018) 318, p. 45. Lithium hydroxide formation, however, is not a requirement for the formation of lithium carbonate.

These reactions pose a problem particularly when using ion conductors in powder form, since in this case the surface area is particularly high. This is frequently associated with poorly reproducible results, and in an extreme case these reactions and the consequent lithium depletion in the material may lead to a considerable loss of conductivity. In other cases, as with Li(Ti, Al)₂(PO₄)₃ based materials, excessive temperatures may lead to amorphization of the crystal phase and to a deterioration in the conductivity. Beforehand there may possibly be depletion of Al in the crystal phase, and AlPO₄ may be formed, and this too may be associated with a conductivity loss.

A variety of ways have been proposed for avoiding these reactions. In the case of macroscopic samples, mechanical removal is possible, albeit costly and inconvenient; in the case of pulverulent ion conductors, however, it is not a solution. A treatment with acid in order to protonate the surface is proposed in US 2016/0149260 A1. Although this does increase the stability with respect to formation of CO₂, a process of this kind may also lead to lithium depletion and hence to a loss in conductivity. Moreover, it represents a further operating step, with adverse consequences for the production costs.

US 2016/0149260 A1 describes a surface treatment of thin garnet coatings or garnet membranes. Acid treatment of powder is not disclosed. The acid-treated samples, moreover, are very sensitive to treatment at elevated temperatures, and so even conventional drying temperatures can lead to decomposition through water loss.

Another possibility is offered by the removal of the water and the CO₂ by a high-temperature treatment, as described for example in JP 2013-219017 A. This, however, requires relatively high temperatures of >650° C., at which there may already be loss of lithium through vaporization and, in the case of powder, a sintering. Moreover, J P 2013-219017 A demonstrates the high-temperature treatment using sintered pellets. Powders are stated merely as a theoretical possibility and are not characterized further in terms of their properties. Whether and, if so, how the method can be carried out on powders is not evident.

Variations of compositions which are less sensitive to reactions with the surrounding air have also been proposed—for example, in JP 2017-061397 A. In general, however, the expectation is that lithium-ion conductors in particular, which have particularly high conductivity, will tend, owing to the associated high lithium mobility, to react with the air and more particularly with the moisture it contains. This is the case particularly for materials of high lithium content.

A further source of Li₂CO₃ in solid-state ion conductors is the use of Li₂CO₃ as a raw material in solid-state reactions. In this case, operationally, there may be residues of unreacted CO₂ in the material.

In some cases as well, the formation of a lithium carbonate layer is deliberately promoted, in order to achieve an improvement in the chemical or electrochemical stability, as for example in US 2017/0214084 A1 or JP 2017-199539 A, both of which do not concern powders. For this purpose, however, it is necessary to control the carbonate content, something which is achievable in general only through small amounts in the base operations, which can be ensured by the disclosure set out.

Also described is the use of carbon in conjunction with solid-state electrolytes. JP 2014-220173 A and JP 2014-220175 A describe a lithium garnet material containing carbon as a constituent of the crystal, this being a disadvantage as it entails an increased electronic conductivity. A further disadvantage is the aging step carried out in a dry atmosphere.

In the production of thin-film electrolytes by way of coating operations, the formation of lithium carbonate may be reduced by means of an additional irradiation with a laser—cf. JP 5841014 B2. This, however, is a relatively costly and inconvenient operation, which can be used only for thin-film electrolytes.

The formation of lithium carbonate in lithium-ion conductors does not occur only for the materials from the class of the garnets; the problem is described for sulfides as well. US 2015/0171428 A1 suppresses the formation of lithium carbonate by means of a low partial pressure of CO₂ in the battery package. Production under protective gas atmosphere, conversely, is discouraged. Moreover, US 2015/0171428 A1 does not relate to a powder.

### SUMMARY OF THE DISCLOSURE

It is, however, not only inorganic carbon constituents which have disadvantageous effects. Depending on the way in which the comminuting step is carried out for the production of the lithium ion-conducting powder materials, the particulate surface may become laden with carbon-containing organic constituents (organic carbon). This is possible accordingly, for example, if the grinding is carried out using the wet mode in particular organic solvents as grinding medium. To a certain degree, consequently, the solvent molecules accumulate on the surface of the resultant particulates because of physical interaction. In an extreme case, there may also be chemical attachment, with formation of covalent chemical bonds. Where such powders are then exposed to high temperatures in subsequent processing, as in the case of sintering, for example, and where at the same time there are reducing conditions, as is the case, for example, if the sintering procedure takes place under a nitrogen atmosphere, the adhering organic constituents are converted into elemental, soot-like or graphite-like carbon (elemental carbon). As a consequence, the resulting product, such as the sintered membrane, for example, has a strong discoloration, which can appear from gray to black. There is a risk, moreover, of excessive electr(on)ic conductivity being established in the product, so making the product no longer usable for deployment in the battery. In the case of temperature treatment under oxidizing conditions, i.e., in air or an oxygen atmosphere, the effect of the formation of elemental carbon generally does not occur, since in this case the organic constituents on the powder particulate surfaces are burned, forming carbon dioxide and water. In this case, however, there is a risk of the carbon dioxide formed in this process joining with the lithium-ion conductor by reaction and so leading to the formation of inorganic carbon (carbonate). The latter could be removed at temperatures of 900° C. or more, but this may entail additional cost and complexity. It is therefore advantageous to keep the organic carbon content low as well.

It is an object of the present disclosure, therefore, to provide a lithium-ion conductor which exhibits low contact resistance to other battery materials, especially to polymer in polymer-solids composites, and high conductivity as a sintered material. The contact resistances to the electrode materials must also be low. Moreover, the lithium-ion conductor is to be free from organic constituents on the surface of the powder particulates, or at least to have a very low fraction of organic constituents, so that, on high-temperature treatment thereof in a reducing atmosphere, no elemental carbon can form or at least no elemental carbon forms in significant quantities.

This object is achieved by the subjects of the claims. The object is achieved more particularly by means of a powder whose particulates consist of a lithium ion-conducting material having a conductivity of at least 10⁻⁵ S/cm,
where the powder has an inorganic carbon content (Total Inorganic Carbon Content (TIC)) of less than 0.4 wt % and/or an organic carbon content (Total Organic Carbon Content (TOC)) of less than 0.1 wt %,
where the particle size when stated as d50 value is in a range from 0.05 μm to 10 μm, and
where the particle size distribution log (d90/d10) is less than 4.

The terms “inorganic carbon content” and “TIC content” and, respectively, “organic carbon content” and “TOC content” are used synonymously in the disclosure.

The terms “particle size”, “grain size” and “particulate size” are used synonymously in the disclosure. The same applies to the terms “particle size distribution” and “grain size distribution”.

The expressions “conductivity”, “ion conductivity” and “lithium-ion conductivity” are used to describe the lithium-ion conductivity, unless otherwise indicated. Conversely to this, the expression “electronic conductivity” describes the electronic conductivity.

The lithium-ion conductivity is determined preferably on solid samples. These may be prepared, for example, from a cooled melt body, or the powder can be pressed and then sintered to form a pellet. The measurement is made preferably by means of electrochemical impedance spectroscopy (EIS). The lithium ion-conducting material preferably has a conductivity of at least 5*10⁻⁵ S/cm, more preferably at least 1*10⁻⁴ S/cm, more preferably still at least 5*10⁻⁴ S/cm. The conductivity is preferably at most 10⁻¹ S/cm, more preferably at most 10⁻² S/cm. All data for values of the lithium-ion conductivity are based on room temperature.

The electronic conductivity ought in the disclosure to be as small as possible. The ratio of lithium-ion conductivity to electronic conductivity is preferably at least 10 000:1.

The powder of the present disclosure preferably has a TIC content of less than 0.4 wt %. More preferably the TIC content is less than 0.35 wt %, more preferably less than 0.3 wt %, more preferably less than 0.25 wt %, more preferably less than 0.2 wt %, more preferably less than 0.15 wt %, more preferably less than 0.1 wt %, more preferably less than 0.05 wt %, more preferably at most 0.04 wt %, more preferably at most 0.03 wt %. A TIC content of at least 0.0001 wt %, at least 0.001 wt % or at least 0.01 wt % may be present in certain embodiments.

The powder of the present disclosure preferably has a TOC content of less than 0.1 wt %. More preferably the TOC content is less than 0.0875 wt %, more preferably less than 0.075 wt %, more preferably less than 0.0625 wt %, more preferably less than 0.05 wt %, more preferably less than 0.0375 wt %, more preferably less than 0.025 wt %, more preferably less than 0.0125 wt %, more preferably at most 0.01 wt %, more preferably at most 0.00875 wt %. A TOC content of at least 0.0001 wt % or at least 0.001 wt % may be present in certain embodiments.

The powder of the present disclosure preferably has a TIC content of less than 0.4 wt % and a TOC content of less than 0.1 wt %. More preferably the TIC content is less than 0.35 wt % and the TOC content is less than 0.0875 wt %. More preferred are a TIC content of less than 0.3 wt % and a TOC content of less than 0.075 wt %, more preferably a TIC content of less than 0.25 wt % and a TOC content of less than 0.0625 wt %, more preferably a TIC content of less than 0.2 wt % and a TOC content of less than 0.05 wt %, more preferably a TIC content of less than 0.15 wt % and a TOC content of less than 0.0375 wt %, more preferably a TIC content of less than 0.1 wt % and a TOC content of less than 0.025 wt %, more preferably a TIC content of less than 0.05 wt % and a TOC content of less than 0.0125 wt %, more preferably a TIC content of at most 0.04 wt % and a TOC content of at most 0.01 wt %, more preferably a TIC content of at most 0.03 wt % and a TOC content of at most 0.00875 wt %.

The TIC+TOC content is calculated as the sum of the TIC content and the TOC content. The powder of the present disclosure preferably has a TIC+TOC content of less than 0.5 wt %. More preferably the TIC+TOC content is less than 0.4375 wt %, more preferably less than 0.375 wt %, more preferably less than 0.3125 wt %, more preferably less than 0.25 wt %, more preferably less than 0.1875 wt %, more preferably less than 0.125 wt %, more preferably less than 0.0625 wt %, more preferably at most 0.05 wt %, more preferably at most 0.03875 wt %. A TIC+TOC content of at least 0.0001 wt %, at least 0.001 wt % or at least 0.01 wt % may be present in certain embodiments.

The TIC and the TOC content are determined preferably with the temperature-fractionated carbon phase analysis according to DIN 19539:2016-12. Since the TIC content is determined substantially by the carbonate content, the TIC content is a good measure of the carbonate content. The low TIC content of the powders of the present disclosure is advantageous because a high lithium carbonate content is associated with poorly reproducible results and may lead to lithium depletion in the material, which in turn leads to a considerable loss of conductivity.

The powder of the disclosure comprises Li₂O. The ratio of the inorganic carbon content (in wt %) to the Li₂O content (in mol %) of the powder is preferably less than 80 ppm/mol %, more preferably less than 70 ppm/mol %, more preferably less than 60 ppm/mol %, more preferably less than 50 ppm/mol %, more preferably less than 40 ppm/mol %, more preferably less than 30 ppm/mol %, more preferably less than 25 ppm/mol %, more preferably less than 20 ppm/mol %, more preferably less than 15 ppm/mol %. The ratio is determined by dividing the TIC content (in wt %) by the Li₂O fraction (in mol %). In the case of a TIC content of 0.04 wt % (400 ppm) and an Li₂O fraction in the powder of 40 mol %, for example, the resulting ratio would be 400 ppm of TIC per 40 mol % of Li₂O, in other words a ratio of 10 ppm/mol %. It can be assumed that the hygroscopic behavior and the tendency to carbonate loading of the solid-state ion conductor material is caused substantially by the Li present therein. Since the latter is present, depending on material, in different amounts, it makes sense to standardize the TIC content to the Li₂O content.

The ratio of the organic carbon content (in wt %) to the Li₂O content (in mol %) of the powder is preferably less than 20 ppm/mol %, more preferably less than 17.5 ppm/mol %, more preferably less than 15 ppm/mol %, more preferably less than 12.5 ppm/mol %, more preferably less than 10 ppm/mol %, more preferably less than 7.5 ppm/mol %, more preferably less than 6.25 ppm/mol %, more preferably less than 5 ppm/mol %, more preferably less than 3.75 ppm/mol %. The ratio is determined by dividing the TOC content (in wt %) by the Li₂O fraction (in mol %). In the case of a TOC content of 0.04 wt % (400 ppm) and an Li₂O fraction in the powder of 40 mol %, for example, the resulting ratio would be 400 ppm of TOC per 40 mol % of Li₂O, in other words a ratio of 10 ppm/mol %.

The ratio of the TIC+TOC content (in wt %) to the Li₂O content (in mol %) of the powder is preferably less than 100 ppm/mol %, more preferably less than 87.5 ppm/mol %, more preferably less than 75 ppm/mol %, more preferably less than 62.5 ppm/mol %, more preferably less than 50 ppm/mol %, more preferably less than 37.5 ppm/mol %, more preferably less than 31.25 ppm/mol %, more preferably less than 25 ppm/mol %, more preferably less than 18.75 ppm/mol %. The ratio is determined by dividing the TIC+TOC content (in wt %) by the Li₂O fraction (in mol %). In the case of a TIC+TOC content of 0.04 wt % (400 ppm) and an Li₂O fraction in the powder of 40 mol %, for example, the resulting ratio would be 400 ppm of TIC+TOC per 40 mol % of Li₂O, in other words a ratio of 10 ppm/mol %.

The particle size of the powder of the disclosure when stated as d50 value is in a range from 0.05 μm to 10 μm, preferably 0.1 μm to 5 μm, more preferably 0.2 μm to 3 μm. Very small particle sizes are technically not advantageous. Toward the upper end the particulate sizes are limited inter alia for some applications—for example, if the particulates are to be integrated into very thin membrane components. Moreover, the specific surface area decreases reciprocally as particulate diameter becomes greater, and so very large particle sizes are not advantageous. Advantages of the claimed particle sizes are, in particular, the low contact resistances and the high sinterability. The sinterability increases greatly with the specific surface area and therefore decreases with increasing particle size. The d50 value indicates that 50% of the particles are smaller than the specified value. The particle size in the disclosure designates the diameter of the particles. The particle sizes are preferably measured using the method of static light scattering, more particularly on a CILAS model 1064 particulate size measuring instrument. The measurement is carried out preferably in isopropanol (refractive index: 1.33) as medium and is evaluated by the Fraunhofer method. An evaluation by the Mie method (Re=1.8, Im=0.8) is also possible. The particle sizes are determined preferably in accordance with ISO 13320:2009-12-01.

The grain size distribution is reported as log (d90/d10) and in the disclosure is less than 4, preferably less than 3, preferably less than 2. The indications “d90” and “d10” indicate that 90% (d90) and 10% (d10), respectively, of the particles are smaller than the specified value, with the particle size denoting the diameter of the particles. The indication “log” denotes the logarithm to the base 10. The grain size distribution of the disclosure is advantageous in terms of the homogeneity of the powder. Narrow size distributions show a relatively strict correlation with the specific surface area of the particulate collective. This surface area can be established more effectively if the methods for powder production yield narrower size distributions. Narrow distributions are also advantageous with regard to some applications-related issues. “Oversize”, i.e. the presence of a small number of very large particulates, for instance, is a disadvantage in the realization of very thin membrane components.

The powder of the disclosure preferably has a specific surface area of at least 0.05 m²/g, more preferably of at least 0.1 m²/g.

The powder of the present disclosure preferably has a water content of at most 30 wt %, more preferably of at most 25 wt %, more preferably of at most 20 wt %, more preferably of at most 15 wt %, more preferably of at most 10 wt %, more preferably of at most 5 wt %, more preferably at most 3 wt %, more preferably at most 2.6 wt %, more preferably at most 1.5 wt %, more preferably at most 1.0 wt %, more preferably at most 0.5 wt %, more preferably at most 0.2 wt %, more preferably at most 0.1 wt %. The water content is determined preferably by the temperature-fractionated carbon phase analysis according to DIN 19539:2016-12. In this analysis the powder is brought continuously via a temperature ramp from room temperature to not more than 1200° C. in a stream of air or oxygen. The organic constituents burn out in this case in the temperature range between 200 and 400° C., producing CO₂ and H₂O. It should be borne in mind that the water content ascertained relates on the one hand to H₂O originating as a product from the combustion of the organic matter. On the other hand it relates to water which originally as such had accumulated physically on the surface of the particles or was present in bound form in the solid material as water of crystallization. In the disclosure the water content refers to the sum of these different fractions.

For solid-state electrolytes an ion conductivity of at least 10⁻⁵ S/cm, better still at least 10⁻⁴ S/cm, is required. At the same time the electronic conductivity ought to be at least 4 to 5 orders of magnitude below, in order to prevent self-discharging of the battery. There is an expectation, furthermore, of chemical resistance with respect to all materials used in the battery, especially to metallic lithium. There ought also, of course, to be sufficient electrochemical stability during charging and discharging (cycling) of the battery. Such requirements are met only by a few known materials. These include, on the one hand, sulfidic systems with lithium, phosphorus and sulfur as main constituents, and on the other hand oxidic systems (oxidic materials) with NaSICon or garnet-like crystal phases. “Oxidic materials” in this context are materials having an oxide content of at least 70 mol %, preferably at least 90 mol %, or materials consisting substantially of oxides. “Sulfidic materials” in this context are materials having a sulfide content of at least 70 mol %, preferably at least 90 mol %, or materials consisting substantially of sulfides. Sulfidic compositions such as Li—S—P, Li₂S—B₂S₃—Li₄SiO₄ or Li₂S—P₂S₅—P₂O₅Li—S—P and Li₂S—P₂S₅—P₂O₅ are frequently produced by grinding the starting materials under protective gas and then carrying out temperature treatment (generally likewise under protective gas) (in this regard see US 2005/0107239 A1, US 2009/0159839 A1). The large-scale technological production of such materials is costly and inconvenient, however, as it must take place under air isolation, since the materials are not stable in air. In the presence of even small amounts of water, particularly, a rapid decomposition is observed. This raises the production and processing costs and poses a safety problem.

Preferred for this reason in the present disclosure are oxidic solid-state ion conductors, such as, for example, lithium lanthanum zirconate (LLZO), lithium aluminum titanium phosphate (LATP), LiSICon and/or NaSICon.

The lithium ion-conducting material of the present disclosure preferably has a structure selected from the group consisting of garnet structure, LiSICon structure and NaSICon structure. LiSICon represents the English expression “Lithium Super Ionic Conductor”. Analogously to this, NaSICon represents the expression “Natrium Super Ionic Conductor”.

The original NaSICon was a sodium zirconium phosphate (Na₁₊ₓZr₂SiₓP₃₋ₓO₁₂, 0<x<3). On account of the high conductivity this substance was designated as “NaSICon=Natrium Super Ion Conductor”. Later, though still before the discovery of LATP, a different, likewise very good lithium-ion conductor was discovered: Li₂₊₂ₓZn₁₋ₓGeO₄. In analogy to NaSICon, this structure was then called LiSICon. The LiSICon structure is nowadays relevant in particular because of the sulfidic systems. For example, Li₁₀GeP₂S₁₂ crystallizes in this structure. A comprehensive description of the LiSICon structure is found for example in Cao et al. (Frontiers in Energy Research, June 2014, volume 2, article 25).

The lithium ion-conducting material of the present disclosure preferably comprises the following components in the specified proportions (in wt % based on oxide):

| Component | Proportion (wt %) |
|---|---|
| Li₂O | 10-25 |
| Oxide of a lanthanoid, preferably at | 40-60 |
| least partly La₂O₃, more preferably | |
| La₂O₃ | |
| Σ ZrO₂, Hf₂O, SnO₂, TiO₂ | 15-35 |
| Σ Al₂O₃, Bi₂O₃, Ga₂O₃, Y₂O₃, | 0-10 |
| Fe₂O₃, Cr₂O₃, In₂O₃, As₂O₃, Sb₂O₃ | |
| Σ Ta₂O₅, Nb₂O₅, V₂O₅, P₂O₅ | 0-20 |
| Σ alkaline earth metal oxides, ZnO | 0-10 |

Alternatively the lithium ion-conducting material preferably comprises the following components in the specified fractions (in wt % based on oxide):

| Component | Proportion (wt %) |
|---|---|
| Li₂O | 2-12 |
| Al₂O₃ | >0-20 |
| TiO₂ | 0-35 |
| GeO₂ | 0-35, preferably 0 |
| P₂O₅ | 30-55 |
| ZrO₂ | 0-16 |
| SiO₂ | 0-15 |
| Σ Nb₂O₅, Ta₂O₅ | 0-30 |
| Σ Cr₂O₃, Fe₂O₃ | 0-15 |
| Ga₂O₃ | 0-15 |
| Y₂O₃ | 0-15 |

The lithium ion-conducting material preferably comprises lithium lanthanum zirconate (LLZO) and/or lithium aluminum titanium phosphate (LATP).

A particularly preferred lithium ion-conducting material of the present disclosure is Li_{1+x-y}M_{y}⁵⁺Mₓ³⁺M_{2-x-y}⁴⁺(PO₄)₃, where x and y are in the range from 0 to 1, (1+x−y)>1 and M is a cation of valence +3, +4 or +5. The stated empirical formula relates inter alia to LATP and also corresponds to the NaSICon structure. LATP represents a lithium-ion conductor with NaSICon structure. M⁵⁺ is preferably Ta⁵⁺ or Nb⁵⁺. M³⁺ is preferably Al³⁺, Cr³⁺, Ga³⁺ or Fe³⁺. M⁴⁺ is preferably Ti⁴⁺, Zr⁴⁺, Si⁴⁺ or Ge⁴⁺.

Another particularly preferred lithium ion-conducting material of the present disclosure is Li_{7+x+y}Mₓ^{II}M₃₋ₓ^{III}M_{2-y}^{IV}M_{y}^{V}O₁₂, where M^{II} represents a divalent cation, M^{III} represents a trivalent cation, M^{IV} represents a tetravalent cation and M^{V} represents a pentavalent cation, where preferably 0≤x<3, more preferably 0≤x≤2, 0≤y<2, and more preferably 0≤y≤1. The stated empirical formula relates inter alia to LLZO.

The present disclosure also relates to a lithium-ion conductor comprising the powder of the present disclosure.

The powder may be incorporated for example as a filler into a polymer electrolyte or into polyelectrolytes. The resultant composite material is referred to in the disclosure as a hybrid electrolyte. The lithium-ion conductor of the present disclosure may therefore be a hybrid electrolyte which as well as the powder of the disclosure comprises at least one polymer electrolyte and/or polyelectrolyte. Preference is given to using crosslinked or noncrosslinked polymers. In preferred embodiments the polymer is selected from the group encompassing polyethylene oxide (PEO), polyacrylonitrile, polyester, polypropylene oxide, ethylene oxide/propylene oxide copolymer, polyethylene oxide crosslinked with trifunctional urethane, poly(bis(methoxy-ethoxy-ethoxide))phosphazene (MEEP), triol-like polyethylene oxide crosslinked with difunctional urethane, poly((oligo)oxyethylene) methacrylate-co-alkali metal methacrylate, polymethyl methacrylate (PMMA), polymethylacrylonitrile (PMAN), polysiloxanes, and also copolymers and derivatives thereof, polyvinylidene fluoride or polyvinylidene chloride, and also copolymers and derivatives thereof, poly(chlorotrifluoroethylene), poly(ethylene-chlorotrifluoroethylene), poly(fluorinated ethylene-propylene), acrylate-based polymers, condensed or crosslinked combinations thereof, and/or physical mixtures thereof.

The polymer, furthermore, preferably comprises at least one lithium ion-containing compound, more preferably at least one lithium salt, more particularly lithium bistrifluoromethanesulfonimidate (LiTFSI). The lithium ion-containing compound serves preferably as lithium ion-conducting compound. The polymer may comprise one or more such compounds.

Suitable lithium salts are selected for example from the group encompassing LiAsF₆, LiClO₄, LiSbF₆, LiPtCl₆, LiAICl₄, LiGaCl₄, LiSCN, LiAlO₄, LiCF₃CF₂SO₃, Li(CF₃)SO₃ (LiTf), LiC(SO₂CF₃)₃, phosphate-based lithium salts, preferably LiPF₆, LiPF₃(CF₃)₃ (LiFAP) and LiPF₄(C₂O₄) (LiTFOB), borate-based lithium salts, preferably LiBF₄, LiB(C₂O₄)₂ (LiBOB), LiBF₂(C₂O₄) (LiDFOB), LiB(C₂O₄)(C₃O₄) (LiMOB), Li(C₂F₅BF₃) (LiFAB) and Li₂B₁₂F₁₂ (LiDFB), and/or lithium salts of sulfonylim ides, preferably LiN(FSO₂)₂ (LiFSI), LiN(SO₂CF₃)₂ (LiTFSI) and/or LiN(SO₂C₂F₅)₂ (LiBETI).

As well as the stated polymer electrolyte, it is also possible alternatively to employ a polyelectrolyte. These are preferably polymers, e.g. polystyrenesulfonate (PSS), which carries Li+ as counterion, or polymerized ionic liquids based on imidazolium, pyridinium, phosphonium or guanidinium, which carry a discrete number of chemically bonded, ionic groups and for that reason are intrinsically lithium ion-conductive.

It is also possible to press the powder of the disclosure to form a compact or to incorporate it into a ceramic slip—with or without addition of a binder—and subject it to a shaping operation, e.g. film casting, casting into a preliminary mold, screen printing, digital printing, slot casting, curtain coating, injection molding, knife coating, rolling. In both cases (compact/slip) the material may be sintered under temperature to give a (purely) inorganic, ion-conducting shaped body. As a result it is possible in particular to obtain an inorganic, ceramic, solid-state ion conductor. The lithium-ion conductor of the present disclosure may therefore be a ceramic solid-state ion conductor.

The lithium-ion conductor of the present disclosure preferably has at least one crystalline phase and at least one (x-ray-)amorphous phase, more particularly exactly one crystalline and exactly one (x-ray-)amorphous phase. Lithium-ion conductors without an (x-ray-)amorphous phase, however, are likewise in accordance with the disclosure.

The present disclosure also relates to the use of the lithium-ion conductor, for example in a separator, an anode, a cathode, a primary battery and/or a secondary cell. More particularly the lithium-ion conductor may be used in solid-state lithium ion batteries (“all-solid-state batteries (ASSB)”), lithium-air batteries or lithium-sulfur batteries, lithium-polymer batteries, and combinations of these. In accordance with the disclosure in particular is the use of the lithium-ion conductor as a solid-state electrolyte in rechargeable lithium batteries.

The disclosure relates on the one hand to the use of the lithium-ion conductor as a separator. Introduced between the electrodes, the separator preserves them from unwanted short circuiting and so ensures the functionality of the system as a whole. The lithium-ion conductor may be applied as a layer to one or both electrodes or may be integrated as a free-standing membrane, as solid-state electrolyte, into the battery.

In accordance with the disclosure as well, on the other hand, is compounding with the electrode active materials. In the case of the hybrid electrolyte, this compounding takes place preferably by inclusion of the electrode active material into the hybrid electrolyte formulation. In the case of the purely inorganic, ceramic electrolyte (ion conductor), on the other hand, compounding takes place preferably by co-sintering with the electrode active material. In this case the solid-state electrolyte ensures the transport of the relevant charge carriers (lithium ions and electrons) to and from the electrode materials and to and from the conducting electrodes, respectively, according to whether the battery is being charged or discharged.

The present disclosure also relates to a method for producing the inventive powder of the present disclosure. The method comprises the following steps:
a) providing a crude product by means of a hot operation which comprises temperatures of at least 900° C., and
b) comminuting the crude product with exclusion of CO₂ sources and/or with exclusion of organic carbon sources.

According to step a) of the method of the disclosure, a crude product is provided by means of a hot operation which comprises temperatures of at least 900° C. The hot operation preferably comprises temperatures of at least 950° C., more preferably at least 1000° C., more preferably at least 1050° C. The high temperatures are advantageous because carbonate decomposition begins significantly beyond 900° C. and then is fully operational at even higher temperatures. It is a particular advantage of the present disclosure that by using such high temperatures it is possible to achieve a particularly low inorganic carbon content, even if Li₂CO₃ is used as raw material. Already described above was the fact that in the prior art there is a problem with Li₂CO₃ as raw material in solid-state reactions, since for operating reasons there may be residues of unreacted CO₂ in the material. The present disclosure, on the other hand, enables the use of Li₂CO₃.

Very generally the hot operation must be run with temperatures >900° C. in order to obtain carbonate-free lithium-ion conductor materials, i.e. to obtain low TIC contents. While a subsequent comminuting operation can in theory be carried out optionally, it is in practice generally necessary, since hot processing at the stated temperatures normally results in granular powder forms whose particulate size distribution is outside the specified range. In an extreme case, indeed, solid blocks are obtained, which in the first step must be pre-comminuted using very harsh techniques. Comminution may take place dry or wet. In each case it should be ensured that there is no loading of the material. In the case of dry grinding, this means that grinding is carried out with a CO₂-free process gas, nitrogen, decarbonized air. Moreover, the only grinding additives that can be used are those which do not leave any organic residues on the surface of the powder particulates. The same is true of wet grinding. For dry grinding this means that only inorganic grinding additives, e.g. fumed silica, can be used, or that these additives are highly volatile, if they are organic-based variants. In the case of wet grinding, the use of organic solvents is generally deprecated, since in that case there is always a likelihood of chemical or at least physical occupation of the particulate surface with solvent molecules. Preference here is given to grinding in water. If, indeed, organic constituents remain in the powder, they must be burnt out in an additional heating step, producing CO₂ and H₂O. The first of these—as the anhydride of carbonic acid—is “captured” directly by the generally very basic lithium-ion conductor material to form carbonate and so entails an increase in the TIC content.

In the case of the synthesis of organic-free ion conductor powder materials, the dry grinding must be carried out only with inorganic additive materials—or only with those organic-based variants which are highly volatile. The wet grinding ought to take place exclusively in water as the grinding medium. For the sintering under reducing conditions, an organic-free material is the prerequisite. The transformation of such residues into elemental carbon must absolutely be avoided in this case. If the sintering temperatures are above 900° C., the presence of carbonate would be tolerable in fact, since the latter would decompose even under the stated conditions.

For use in hybrid electrolytes, the presence of carbonate must absolutely be avoided, since in this case there is a very high risk that undesirably high interfacial resistances develop between ceramic and polymer-based ion conductor and hence the usefulness of the hybrid electrolyte is destroyed. In this case a modification with organic radicals may in certain circumstances actually be helpful.

The hot operation is preferably selected from the group consisting of (i) melt, (ii) reactive sintering, (iii) calcining of sol-gel precursors, and (iv) bottom-up synthesis in a pulsation reactor. The melt more particularly is a glass-based melt.

Mention may be made, illustratively, of the provision of LLZO and/or LATP by way of reactive sintering, more particularly at temperatures of at least 900° C., preferably at least 950° C., more preferably at least 1000° C., more preferably at least 1050° C.

Temperatures of at least 900° C., preferably at least 950° C., more preferably at least 1000° C., more preferably at least 1050° C. are also particularly advantageous for the conversion of the sol-gel precursor into the desired end product in the course of the calcining. In particular the crude product may be ceramicized by the temperature treatment, with formation of a crystal phase. A cubic structure is particularly preferred. These structures are not confined to production by way of calcining of sol-gel precursors, but instead may likewise be obtained in the case of production from the melt, during reactive sintering, and in the bottom-up synthesis in a pulsation reactor.

For the provision of the crude product via calcining of sol-gel precursors, the starting materials are preferably dissolved in distilled water. Preferred starting materials for the provision of LLZO are zirconium acetylacetonate, lanthanum acetate sesquihydrate, lithium acetate dihydrate, and aluminum chloride hexahydrate. The reaction mixture containing the starting materials is stirred preferably for a period of 8 to 16 hours, preferably 12 hours, at room temperature, i.e. at 20° C. to 25° C. The solvent is subsequently removed preferably by evaporation, using a rotary evaporator, for example. The subsequent calcining at temperatures of at least 900° C., preferably at least 950° C., more preferably at least 1000° C., more preferably at least 1050° C. takes place preferably for a time of more than 5 hours, more preferably for a period of 6 to 8 hours. This is advantageous not only for the development of the desired crystal phases but also for further reduction both in the TOC content and in the TIC content, with the reduction in the TOC content being very largely concluded at temperatures between 400 and 600° C. The reduction in the TIC content begins significantly, on the other hand, only at temperatures of 900° C. or more. The calcining is carried out preferably under CO₂-free, synthetic air. In this way it is possible to prevent reloading of the material, especially LLZO or LATP, with water and, in particular, CO₂ from the atmosphere.

For the bottom-up synthesis the starting materials are preferably dissolved in nitric acid. For the bottom-up synthesis of LLZO, starting materials used are preferably zirconium carbonate hydrate, lanthanum carbonate hydrate, lithium carbonate, and aluminum nitrate nonahydrate. The reaction mixture containing the starting materials is stirred preferably for a period of 8 to 16 hours, preferably 12 hours, at room temperature, i.e. at 20° C. to 25° C., and then conveyed into a pulsating stream of hot gas, where it is atomized via a nozzle into the reactor interior, where it is thermally treated. In the combustion chamber an oscillating oxyhydrogen flame is preferably generated, more particularly one which has a slightly oxidizing character. The H₂/O₂ volume flow ratio is preferably in a range from 1.5/1 to 2/1, more preferably at 1.85/1. Owing to the absence of CO₂, the oxyhydrogen flame is particularly advantageous and therefore preferable to an alternatively employable city gas flame. On the other hand it is possible, owing to very short residence times in the pulsating stream of hot gas, for only an intermediate to be produced, which must be converted into the actual end product in a downstream heating step. In this case temperatures of 900° C. and higher are preferably selected. Under these conditions it is also possible for carbonate to be decomposed again, having formed on an intermediate basis in the intermediate as a result of the use of city gas or liquid gas. The use of city gas or liquid gas is therefore likewise possible.

The temperature of the resonance tube is preferably in a range from 750° C. to 900° C., more preferably 800° C. to 850° C. The powder obtained (more particularly LLZO or LATP powder) is preferably brought subsequently in a CO₂-free oxygen atmosphere to a temperature of at least 900° C., preferably at least 950° C., more preferably at least 1000° C., more preferably at least 1050° C. Compaction of the powder particulates can be achieved as a result. Moreover, the TIC content can be reduced further by the high temperatures. The mass fraction of CO₂ in the CO₂-free oxygen atmosphere is preferably at most 300 ppm, more preferably at most 200 ppm, more preferably at most 100 ppm, more preferably at most 50 ppm. The use of CO₂-free atmosphere (whether air, oxygen, or else nitrogen) is useful, but not absolutely necessary. At temperatures of 900° C. the TIC content begins to reduce significantly with release of CO₂—even if CO₂ is present in the atmosphere in proportions as customary in standard atmosphere. At the stated temperatures, this does delay the decomposition reaction somewhat, but does not prevent it. Especially if the product has a slight flow of the gas over it during processing, this disadvantage tends to be negligible, since in that case a flow equilibrium is established in which the CO₂ coming from the decomposition reaction is discharged continuously from the reaction space. A CO₂-free atmosphere is therefore not absolutely necessary.

In all of the hot operations described there is no harm in the incidence of carbonates as intermediates, since ultimately they are successfully decomposed again because of the high temperatures. A low TIC content can therefore be obtained in particular by the handling and post-processing, and it is possible accordingly to use Li₂CO₃ as a raw material in a hot operation. Moreover, the significantly higher temperatures which are employed in the melting operations in accordance with the disclosure are a further means of producing Li-ion conductors with low TIC content, such as carbonate-free Li-ion conductors or those with very low carbonate content, for example.

The crude product provided according to step a) takes the form preferably of a monolithic block, lumps, (broken) strip (ribbons), grit, frit, flakes or coarse powder.

According to step b) of the method of the disclosure, the crude product is comminuted in the absence of CO₂ sources. In other words, it is ensured that the grindstock does not come into contact with CO₂ from the air or from other potential CO₂ sources. The comminution may be achieved via dry grinding or wet grinding. Step b) may be a single step. Alternatively step b) may also comprise two or more comminuting steps. Step b) converts the crude product into the powder form with the desired particle size and grain size distribution. Preferably the comminuting step b) comprises one or more of the following steps:
b1) comminution by means of hammer and chisel,
b2) comminution by means of jaw crusher, ball mills and/or hammer mills,
b3) comminution by means of ball, impact and/or planetary mills,
b4) comminution by means of opposed-jet mills operated with process gases or steam, dry and/or wet ball mills, dry and/or wet agitator ball mills and/or by high-energy grinding in high-kinetic-energy rotor ball mills.

With particular preference the comminuting step b) comprises the step b4).

A feature of high-kinetic-energy rotor ball mills is that in these mills the grinding bodies are brought preferably to velocities of up to 15 m/s, more preferably up to 20 m/s. Preference is given to velocities of more than 5 m/s, more preferably more than 10 m/s.

Step b1) relates in particular to the comminution of monolithic blocks. Step b2) relates in particular to the comminution of crude products in the form of lumps or (broken) strips (i.e. ribbons). Step b3) relates in particular to the comminution of grit, frits, flakes or coarse powders, preferably those having particle sizes in the range from 1 mm to 10 mm when stated as d50 value. Step b4) relates in particular to the comminution of coarse powders, preferably those having particle sizes in the range from 0.05 mm to <1 mm when stated as d50 value.

The particle size is determined preferably by way of analytical sieving. In this case the powder under test is applied to a sieve tower, which consists of a cascade of sieves having different fabric fineness (coarse fabric at the top, fine fabric at the bottom). Material is caused to pass through the various sieves by placing the sieves suitably into motion (shaking, vibrating, etc.). If the particles are too large for a fabric with a particular fineness, they are retained by the corresponding fabric and no longer continue to fall. In this way the powder is separated into different size fractions. In the case of non-spherical particulates having a significant aspect ratio, the point with the lowest geometrical width (in projection direction) is critical for the capacity to pass through the meshes. On finer coarse powders (with a particle size <100 μm), the particle size distribution is determined by means of the static light scattering method. This determination of the particle sizes takes place preferably in accordance with ISO 13320:2009-12-01.

In the case of comminuting steps which are operated dry, operation takes place preferably in a CO₂-free atmosphere (e.g. under inert gas such as nitrogen or argon, in decarbonized or synthetic air, or in (preferably pure) oxygen atmosphere, etc.). Mixtures of different CO₂-free gases are also possible. The mass fraction of CO₂ in the CO₂-free atmosphere is preferably at most 300 ppm, more preferably at most 200 ppm, more preferably at most 100 ppm, more preferably at most 50 ppm. In order to ensure sufficiently low interfacial resistances between ceramic and polymer-based solid-state ion conductors in a hybrid electrolyte, and also for (glass-)ceramic solid-state ion conductors which are to be sintered at temperatures below 900° C. (irrespective of whether under oxidizing or reducing conditions), the CO₂-free atmosphere is an absolutely necessary prerequisite. For powders of solid-state ion conductor materials which—independently of the redox potential of the atmosphere—are to be compacted at temperatures of 900° C. and higher, on the other hand, this is not the case.

In the course of the dry grinding it is possible in principle to add a grinding additive to the grindstock, with the objective of reducing the formation of agglomerates. Ideally this additive is based on an inorganic compound (e.g. use of fumed silica, which is amorphous SiO₂). Such additives may for example be low molecular mass alcohols (methanol, ethanol, n-propanol, isopropanol) or ketones (acetone, ethyl methyl ketone). Alternatively additives on an organic basis may be added to the operation, provided they are sufficiently volatile and do not lead to adhesion of organic radicals on the surface of the powder particulates consisting of the lithium ion-conducting material. For solid-state ion conductors which are to be sintered under reducing conditions, this is absolutely necessary—irrespective of the temperature used when sintering. For solid-state ion conductors which are to be incorporated into hybrid electrolytes, on the other hand, it is not vital. Here a targeted modification with selected organic radicals may even be useful in certain circumstances. It may indeed not be possible to get around such a modification at the end.

In contrast to the dry operations, wet operations are more particularly those wherein the crude product is processed in a suspension having a solids content of not more than 60 vol %, more preferably not more than 40 vol %, very preferably not more than 30 vol %. The fluid phase acts as a protection with respect to CO₂ contact from the atmosphere, but should itself not be a source of addition of organic radicals and/or CO₂ formation—either in said comminuting step or in a potentially downstream processing step of another kind (e.g. temperature treatment). The fluid phase may be, for example, water. The fluid phase is preferably not an organic solvent, more particularly not isopropanol. The reason is that the fluid phase is not to be a source of the accumulation of organic radicals on the particle surface and/or of the formation of CO₂ and of carbonate formation after the reaction of said CO₂ with the solid-state ion conductor material. This is so especially for the case where the lithium ion-conducting powder material is to be sintered subsequently at temperatures below 900° C. under reducing conditions. Without a further upstream temperature treatment step in the form of the prior burning-out of the organic matter at moderate temperatures, e.g. 400-600° C., in an oxidizing atmosphere, this would not be feasible even at potentially higher sintering temperatures. At such temperatures, in fact, the organic matter is decomposed. The CO₂ formed as a reaction product in this case, however, is picked up by the lithium-ion conductor material, which in general possesses a (highly) basic character, and carbonate is formed. In the downstream sintering step, the removal thereof is no longer possible, since the temperatures in this case are below the 900° C. required for such removal. This would be possible again only at higher sintering temperatures.

In cases of grinding in isopropanol it has been found that in this case the particulate surfaces are esterified, in other words that organic radicals attach covalently to the surface and continue to be present there even after the drying step in a rotary evaporator. As a consequence of moderate temperature treatment at T<900° C. in air, these residues undergo thermal decomposition to form CO₂ and H₂O and lead here to said unwanted formation of carbonate. This is not automatically the case for all organic solvents. There are also variants which do not attach so firmly to the particulate surface and can be detached again physically from the particulate surface either in the course of the drying step itself or else in the initial stage of a temperature treatment, without any accompanying significant thermal decomposition with formation of CO₂. Preferably, however, the fluid phase is not an organic solvent. The fluid phase is preferably water.

The comminution of step b4) takes place for example by means of an opposed-jet mill operated with process gases. Nitrogen gas is a particularly preferred process gas. The process gas is used preferably with a pressurization in a range from 4 bar to 8 bar, more particularly from 5 bar to 7 bar.

The comminution of step b4) may also take place, for example, by means of a ball mill, more particularly with a dry ball mill. The comminution occurs preferably under a nitrogen gas atmosphere. Grinding media used are preferably cylindrical Al₂O₃ grinding media, preferably Cylpebs, more particularly having a diameter in a 15 mm to 25 mm range, as for example 21 mm. The grinding media may be separated from the powder of the disclosure by sieving.

The comminution of step b4) may also take place, for example, by means of a wet agitator ball mill. Water is a particularly suitable liquid grinding medium for producing a dispersion of the crude product. Grinding media used may be ZrO₂ grinding beads, for example, more particularly those having a diameter of about 1 mm. The comminution takes place in a grinding slip made up of crude product, liquid grinding medium and, optionally, dispersant added for stabilization. Preferably no dispersant is used, and so the grinding slip consists preferably only of the crude product for grinding and the liquid grinding medium. The grinding media likewise present are by definition not a constituent of the grinding slip. Following the comminution, the grinding slip is subjected to drying, more particularly to freeze-drying, at a temperature for example in a range from −20° C. to −40° C., preferably −30° C., and at a pressure in a range from 0.5 to 1.0 bar. Through subsequent successive heating, the frozen water can be removed from the solid slip residue by sublimation gradually, in a period, for example, of around 10 to 30 hours, preferably 20 hours. It is advantageous to bake the powder of the disclosure after drying, in—for example—an oven traversed by a flow of nitrogen gas, for 2 to 6 hours, preferably 4 hours, at a temperature of 600° C. to 800° C., preferably 700° C.

In summary it can be stated that for the sintering under reducing conditions a material of low TOC content is required in order to prevent the conversion of corresponding residues into elemental carbon. Where the sintering temperatures are above 900° C., the presence of carbonate would in fact be tolerable here, since the latter would also decompose under the stated conditions.

For use in hybrid electrolytes, on the other hand, the presence of carbonate should be avoided as far as possible, since in this case there is a very high risk of unwantedly high interfacial resistances developing between ceramic and polymer-based ion conductor and hence of adverse effects on the usability of the hybrid electrolyte, or of the latter even becoming unusable. Modification with organic radicals, on the other hand, may even be useful in this case under certain circumstances.

The method of the disclosure for producing the lithium ion-conducting powder may comprise one or more further steps additionally to the steps a) and b). The method preferably comprises the following step:
c) removal of a powder fraction from the powder obtained according to step b), by means of a classifier and/or a cyclone.

Step c) takes place likewise with exclusion of CO₂ sources.

### BRIEF DESCRIPTION OF THE SEVERAL VIEWS OF THE DRAWINGS

FIG. 1 shows the results of the temperature-fractionated carbon phase analysis according to DIN 19539 of comparative example 7. The temperature profile employed in the analysis is represented as a solid line and is based on the right-hand y-axis. The TIC content is shown as a shaded area with dash outlining, and relates to the left-hand y-axis. The x-axis shows the time in seconds.

FIG. 2 shows the results of the temperature-fractionated carbon phase analysis according to DIN 19539 of the inventive working example 3. The temperature profile employed in the analysis is represented as a solid line and is based on the right-hand y-axis. The TIC content is shown as a shaded area with dash outlining, and relates to the left-hand y-axis. The x-axis shows the time in seconds.

FIG. 3 shows the results of the temperature-fractionated carbon phase analysis according to DIN 19539 of comparative example 9. The temperature profile employed in the analysis is represented as a solid line and is based on the right-hand y-axis. The TOC content is shown as a shaded area with dash outlining, and relates to the left-hand y-axis. The x-axis shows the time in seconds.

### DETAILED DESCRIPTION OF THE DISCLOSURE

### Working Examples of the Disclosure

1 Carbonate-Free LLZO Powder Produced Via a Melting Operation Using Li₂CO₃ as Raw Material

Carbonate-free LLZO powder can be melted as described below using Li₂CO₃ as raw material: the crucible used is what is called a skull crucible, as described for instance in DE 199 39 782 C1. The skull technology uses a water-cooled crucible in which in the course of the melting a cooler protective layer is formed from the material to be melted. Accordingly no crucible material is dissolved during the melting procedure. The input of energy into the melt is realized by means of a radiofrequency incoupling via the surrounding induction coil into the liquid-melt material. A condition here is the sufficient conductivity of the melt, this being provided in the case of lithium garnet melts by the high lithium content. During the melting-in procedure, there is evaporation of lithium, which can easily be corrected by a lithium excess. For this purpose it is normal to operate with a slight lithium excess.

In the example the batch used comprised La₂O₃, Li₂CO₃, Nb₂O₅ and ZrO₂, for the production of an Nb-doped lithium lanthanum zirconate having a nominal composition of Li₇₊ₓLa₃Zr_{1.5}Nb_{0.5}O₁₂. The raw materials were mixed in accordance with the composition and introduced into the skull crucible, which was open at the top. The batch had first to be preheated in order to attain a certain minimum conductivity. This was done using a burner heating system. When the coupling temperature was reached, the further heating and homogenization of the melt was achieved through radiofrequency incoupling via the induction coil. To improve the homogenization of the melts, stirring took place with a water-cooled stirrer. Following complete homogenization, direct samples were taken from the melt, while the rest of the melt was cooled more slowly by the switching-off of the radiofrequency. The material produced in this way may be converted in principle into a glass-ceramic material with garnet-like main crystal phase, either by direct solidification from the melt or by quenching followed by a temperature treatment (ceramicization).

Independently of the cooling, the samples taken directly from the melt showed spontaneous crystallization, and so there was no need for a downstream ceramicization treatment.

Comminution may be carried out for example as in one of examples 2 to 4.

2. Carbonate- and Organic-Free LLZO Powder as Solid-State Lithium-Ion Conductor Produced by Wet Grinding in Water with Subsequent Freeze Drying and Temperature Treatment at 700° C. Under Reduced Pressure

1 kg of coarsely fractionated lithium lanthanum zirconium oxide powder with a grain size <63 μm are dispersed in 2.33 L of water, as far as possible free from agglomerates, using a dissolver. The suspension is subsequently introduced into the initial-charge container of an agitator ball mill and is ground for 2.5 h using a grinding chamber with pin-type mill agitator, employing the multiple-passage mode. This grinding chamber is filled with grinding beads consisting of ZrO₂ (fill level: 74%) which have a diameter of around 1 mm. Grinding is ended when 50% of the particulates present in the grinding slip have a diameter of approximately 0.78 μm, 90% have a diameter of around 1.63 μm and 99% have a diameter of around 2.71 μm. The particulate sizes are measured using the static light scattering method on a CILAS model 1064 particulate size measuring instrument. The measurement is carried out in water (refractive index: 1.33) as medium and evaluated according to the Mie method (Re=1.8, Im=0.8).

After the grinding, the grinding slip is subjected to drying in a freeze dryer. For this purpose it is first poured extensively into product trays intended for the purpose, and then frozen under reduced pressure at 0.5 to 1.0 bar and a temperature of −30° C. By subsequent successive heating of the product tray bases, the frozen water is removed from the solid slip residue gently by sublimation gradually, in a period of around 20 h. By means of the temperature-fractionated carbon phase analysis according to DIN 19539, the total of the TOC content and TIC content of the LLZO powder wet-ground in water is determined to be 0.4%, with the carbon detected consisting predominantly of inorganic carbon. The water content is determined to be 25%. The total carbon content in this case matches the sum of TOC content and TIC content, since there is no EC (elemental carbon) contribution.

In order to reduce the loading with water and particularly CO₂, the LLZO powder, immediately after freeze drying, is introduced directly into a Nabertherm model N20/H oven, traversed by a flow of nitrogen gas, and is baked at 700° C. for 4 h.

After the baking, the LLZO powder is taken from the cooled oven, traversed by a flow of nitrogen gas, and is vacuum-packed directly into pouches consisting of metallized polyethylene.

With the aid of the temperature-fractionated carbon phase analysis according to DIN 19539, the TIC content of the LLZO powder wet-ground in water and baked, after freeze drying, under reduced pressure at 700° C. for 4 h is determined to be 0.09%, the water content to be 0.8%. The total carbon content in this case matches the TIC, since there are no TOC and EC contributions.

3. Carbonate- and Organic-Free LLZO Powder as Solid-State Lithium-Ion Conductor Produced by Dry Grinding on an Opposed-Jet Mill Using Nitrogen as Process Gas

5 kg of coarsely fractionated lithium lanthanum zirconium oxide powder with a grain size <1 mm are applied to an opposed-jet mill. The jet milling takes place through a ceramic die using nitrogen gas as grinding medium with a pressurization of 6 bar. With the downstream classifier, a powder fraction is obtained which, following further removal of fines in a cyclone, has a particulate size distribution with a d₅₀=2.0 μm, d₉₀=5.9 μm and d₉₉=6.7 μm.

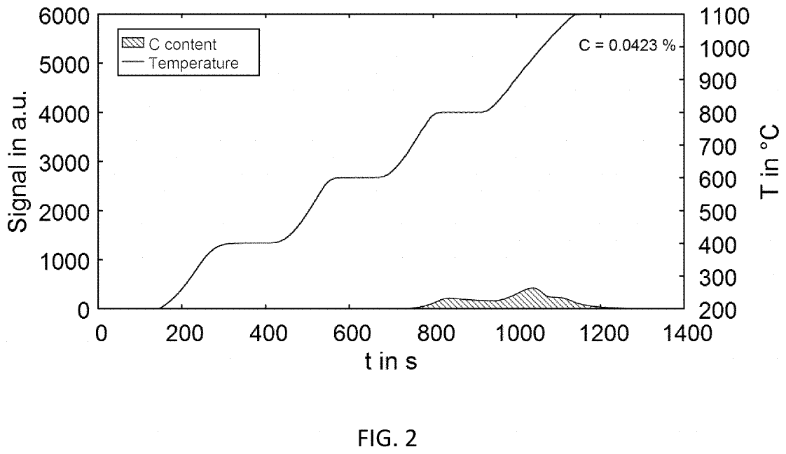

With the aid of the temperature-fractionated carbon phase analysis according to DIN 19539, the TIC content of the LLZO powder comminuted on the opposed-jet mill using nitrogen as process gas is determined to be 0.04%, the water content to be 0.4%. The total carbon content in this case too matches the TIC, since there are no TOC and EC contributions. The results of the determination of the TIC content are shown in FIG. 2.

4. Carbonate- and Organic-Free LATP Powder as Solid-State Lithium-Ion Conductor Produced by Dry Grinding on a Ball Mill Using Nitrogen as Process Gas

For the comminution of lithium aluminum titanium phosphate in a ball milling operation, 160 g of the solid-state ion conductor material are charged together with 2.16 kg of cylindrical grinding media—Al₂O₃Cylpebs Ø=21 mm, H=21 mm—into a gastight 3.6 L polyethylene drum (Ø=198 mm, H=171 mm) and rotated on a roller bed (rotation frequency: 140 rpm) for 5 h at a rotational velocity of 1.45 m/s. The charging of the drum and the subsequent sample preparation are carried out under nitrogen gas atmosphere in a portable glovebox, in order to prevent the material becoming loaded with water and CO₂ from the standard air atmosphere.

The grindstock was subsequently separated from the grinding media by sieving in a portable glovebox of brand Captair® Pyramid under nitrogen gas atmosphere with a humidity <2% and was vacuum-packed directly into pouches consisting of metallized polyethylene.

With the aid of the temperature-fractionated carbon phase analysis according to DIN 19539, the TIC content of the LLZO powder comminuted on the ball mill using nitrogen as process gas is determined to be 0.03%, the water content to be 0.1%. In this case as well, total carbon content and TIC are again identical. No TOC and EC contributions can be detected.

5. Carbonate- and Organic-Free LLZO Powder as Solid-State Lithium-Ion Conductor Produced in a Pulsating Stream of Hot Gas Generated from an Oxyhydrogen Flame

1.56 kg (4.7 mol) of zirconium carbonate hydrate were dissolved in at least 10.0 kg of 2.7 M nitric acid in a suitable reaction vessel. 3.83 kg (7 mol) of lanthanum carbonate hydrate were dissolved in 10 kg of 2.7 M nitric acid in a further reaction vessel. 1.33 kg (18 mol) of lithium carbonate and 0.22 kg (0.58 mol) of aluminum nitrate nonahydrate were dissolved in 5.0 kg of 2.7 M nitric acid in a third reaction vessel. Following complete dissolution of the components, the solutions were combined and the resultant reaction mixture was stirred at room temperature for 12 hours. By means of a peristaltic pump, the solution is conveyed into a pulsating stream of hot gas with a volume flow rate of 3 kg/h, where it is finely atomized via a 1.8 mm titanium nozzle into the reactor interior, where it is thermally treated. Generated in the combustion chamber for this purpose is an oscillating oxyhydrogen flame which has a slightly oxidizing character (ratio: H₂/O₂ volume flow=1.85/1). The temperature of the resonance tube is held at 825° C.

The predominantly amorphous, pulverulent intermediate generated in the pulsating stream of hot gas is introduced into a cuboidal alpha-alumina crucible, which is placed into a chamber kiln. In the kiln, the calcining material is brought to a temperature of 1050° C. in a CO₂-free oxygen atmosphere for complete conversion into the desired crystalline LLZO phase.

By means of the temperature-fractionated carbon phase analysis according to DIN 19539, the TIC content of the LLZO powder produced in the pulsating stream of hot gas, the stream of hot gas being generated in turn using an oxyhydrogen flame, is determined to be 0.06%, the water content to be 0.9%. Here again, total carbon content and TIC content are identical.

6. Carbonate-Free LLZO Powder as Solid-State Lithium-Ion Conductor Produced Via a Sol-Gel Reaction with Subsequent Calcining of the Resultant Intermediate Using CO₂-Free Synthetic Air

To produce an aqueous sol-gel precursor, 22.9 g (0.047 mol) of zirconium acetylacetonate are dissolved in at least 100 mL (5.56 mol) of distilled water. In parallel with this, 24.0 g (0.07 mol) of lanthanum acetate sesquihydrate are dissolved in 100 mL (5.56 mol) of distilled water in a further reaction vessel. Furthermore, in a third reaction vessel, 18.4 g (0.18 mol) of lithium acetate dihydrate and 1.4 g (0.0058 mol) of aluminum chloride hexahydrate are dissolved in 50 mL (2.78 mol) of distilled water.

Finally all three of the stated solutions are combined and the resultant reaction mixture is stirred at room temperature for 12 hours.

The solvent is removed preferably with a rotary evaporator. The precursor can be concentrated rapidly at a water bath temperature of 90° C. with continuous pressure reduction.

To obtain a crystalline, ion-conducting powder, the intermediate obtained (precursor powder or resin) is calcined in a crucible in a radiation kiln. To obtain a cubic modification, temperatures in this case of at least 1000° C. and a hold time of more than 5 hours are advantageous. 1000° C. and 7 hours may be stated as optimum temperature-time conditions. During the calcining, all of the carbonate constituents which are introduced with the precursor compound and/or which form in the solution and also in the dried precursors and/or which form on an intermediate basis in the initial stage of the calcining are decomposed, owing to the action of the temperature. In order to ensure complete, residue-free combustion of the organic constituents present in the precursors, but at the same time to avoid the fully calcined material becoming reloaded with water and in particular CO₂ from the atmosphere, the kiln is charged with CO₂-free, synthetic air during the calcining.

By means of the temperature-fractionated carbon phase analysis according to DIN 19539, the TIC content of the LLZO powder produced via the sol-gel route and calcined using synthetic air is determined to be 0.08%, the water content to be 1.4%. Here again the following applies: total carbon content=TIC content.

Non-Inventive, Comparative Examples

Carbonate-Containing LLZO Powder as Solid-State Lithium-Ion Conductor Produced by Wet Grinding in Isopropanol with Subsequent Drying in a Rotary Evaporator and Temperature Treatment at 700° C. in Ambient Air

1 kg of coarsely fractionated lithium lanthanum zirconium oxide powder with a grain size <63 μm are dispersed in 2.33 L of isopropanol, as far as possible free from agglomerates, using a dissolver. The suspension is subsequently introduced into the initial-charge container of an agitator ball mill and is ground for 2.5 h using a grinding chamber with pin-type mill agitator, employing the multiple-passage mode. This grinding chamber is filled with grinding beads consisting of ZrO₂ (fill level: 74%) which have a diameter of around 1 mm. Grinding is ended when 50% of the particulates present in the grinding slip have a diameter of approximately 1.64 μm, 90% have a diameter of around 5.01 μm and 99% have a diameter of around 7.83 μm. The particulate sizes are measured using the static light scattering method on a CILAS model 1064 particulate size measuring instrument. The measurement is carried out in isopropanol (refractive index: 1.33) as medium and evaluated according to the Fraunhofer method.

After the grinding, the grinding slip is subjected to drying on a rotary evaporator. For this purpose it is first transferred into a 20 L round-bottom flask. The isopropanol is subsequently distilled off over a period of 10 to 15 h under reduced pressure, at pressures of 25 to 50 mbar, by rotating the flask, immersed into a heated water bath, with a rotation frequency, where the temperature of the water bath is 55 to 60° C.

The powder dried on the rotary evaporator is subsequently introduced into a Nabertherm model N20/H oven operated under ambient air, and is baked in an air atmosphere at 700° C. for 4 h, and after the temperature treatment is allowed to cool to room temperature.

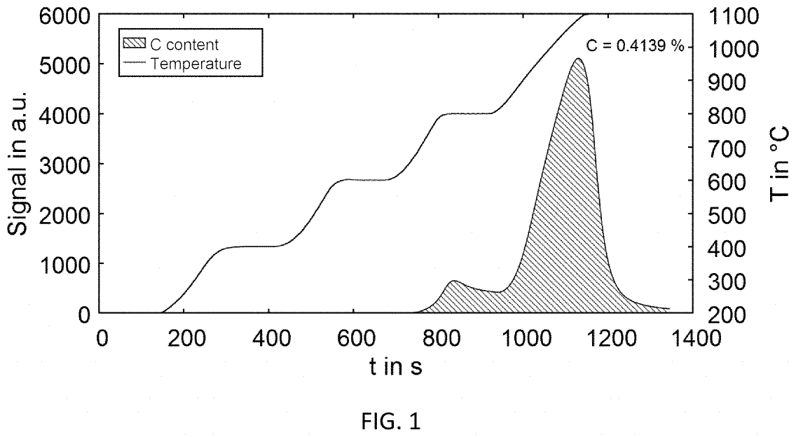

By means of the temperature-fractionated carbon phase analysis according to DIN 19539, the TIC content of the LLZO powder, ground in isopropanol in an agitator ball mill and conditioned in air at 700° C. for 4 h, is determined to be 0.4%. In the course of the temperature treatment at 700° C. for 4 h, organic residues (TOC) bound on the particulate surfaces after the grinding are decomposed thermally into CO₂ and water. By reaction with the solid-state ion conductor material, the CO₂ is converted into carbonate and is detected as TIC in the carbon phase analysis. TOC and EC contributions are no longer detectable here. The results are shown in FIG. 1. The carbon here is liberated in relevant amounts only at temperatures above 800° C., meaning that it is what is called inorganic carbon which comes from a carbonate compound. The water content of the material is around 5%.

8. Carbonate-Containing LLZO Powder as Solid-State Lithium-Ion Conductor Produced by Dry Grinding on an Opposed-Jet Mill Using Compressed Air as Process Gas

5 kg of coarsely fractionated lithium lanthanum zirconium oxide powder with a grain size <1 mm are applied to an AFG100 opposed-jet mill module which is installed on a multi-process unit from Hosokawa-Alpine. The jet milling takes place through a ceramic die with 1.9 mm diameter using compressed air as grinding medium with a pressurization of 6 bar. With the downstream classifier, which rotates with a rotation frequency of 10 000 rpm, a powder fraction is obtained which, following further removal of fines in a cyclone, has a particulate size distribution with a d₅₀=2.5 μm, d₉₀=6.7 μm and d₉₉=7.9 μm.

With the aid of the temperature-fractionated carbon phase analysis according to DIN 19539, the TIC content of the LLZO powder comminuted on the opposed-jet mill using compressed air as process gas is determined to be 0.83%, the water content to be 2.8%. Where grinding is carried out in the manner described, the CO₂ from the air used as process gas reacts with the solid-state ion conductor material to form carbonate, and is detected again as TIC content in the downstream carbon phase analysis. In this case again, TOC and EC contributions are not detectable.

9. LATP Powder, Carrying Organic Residues, as Solid-State Lithium-Ion Conductor Produced by Wet Grinding in Isopropanol with Subsequent Drying in a Rotary Evaporator

1 kg of a lithium aluminum titanium phosphate powder, coarsely ground in a planetary mill, with a grain size <63 μm is dispersed in 2.33 L of isopropanol, as far as possible free from agglomerates, using a dissolver. The suspension is subsequently introduced into the initial-charge container of an agitator ball mill and is ground for 30 min using a grinding chamber with pin-type mill agitator, employing the multiple-passage mode. This grinding chamber is filled with grinding beads consisting of ZrO₂ (fill level: 74%) which have a diameter of around 1 mm. Grinding is ended when 50% of the particulates present in the grinding slip have a diameter of approximately 1.03 μm, 90% have a diameter of around 2.44 μm and 99% have a diameter of around 3.78 μm. The particulate sizes are measured using the static light scattering method on a CILAS model 1064 particulate size measuring instrument. The measurement is carried out in water as medium and evaluated according to the Fraunhofer method.

After the grinding, the grinding slip is subjected to drying on a rotary evaporator. For this purpose it is first transferred into a 20 L round-bottom flask. The isopropanol is subsequently distilled off over a period of 10 to 15 h under reduced pressure, at pressures of 25 to 50 mbar, by rotating the flask, immersed into a heated water bath, with a rotation frequency, where the temperature of the water bath is 55 to 60° C.

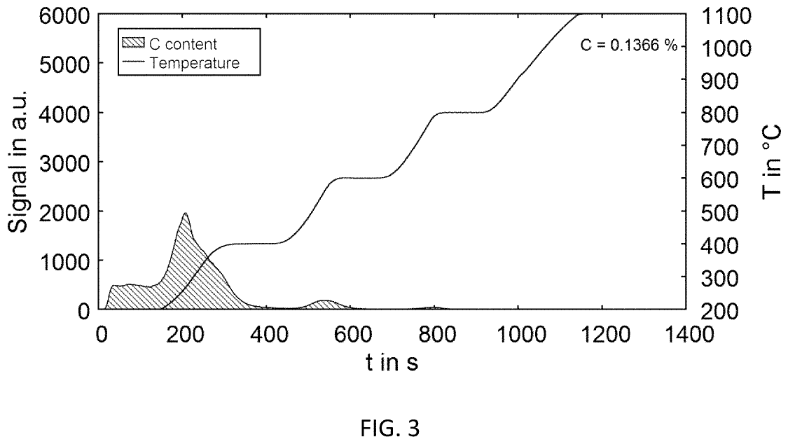

By means of the temperature-fractionated carbon phase analysis according to DIN 19539, the TOC content of the LATP powder, milled in isopropanol in an agitator ball mill and dried on a rotary evaporator, is determined to be 0.14%. TIC and EC contributions are not detectable here, meaning that in this case the total carbon content is identical to the TOC content. The results are shown in FIG. 3. The water content of the material is around 0.7%.

What is claimed is:

1. A powder with particulates of a lithium ion-conducting material having a conductivity of at least 10⁻⁵ S/cm,
wherein the powder has an inorganic carbon content (Total Inorganic Carbon Content (TIC)) of less than 0.4 wt % and/or an organic carbon content (Total Organic Carbon Content (TOC)) of less than 0.1 wt %,
wherein particulates have a d50 particle size in a range from 0.05 μm to 10 μm, and
wherein the particulates have a particle size distribution log (d90/d10) of less than 4.

2. The powder as claimed in claim 1,
wherein the powder comprises Li₂O, and
wherein the inorganic carbon content (in wt %) is in a ratio to the Li₂O content (in mol %) that is less than 80 ppm/mol % and/or the organic carbon content (in wt %) is in a ratio to the Li₂O content (in mol %) that is less than 20 ppm/mol %.

3. The powder as claimed in claim 1, wherein the powder has a specific surface area of at least 0.05 m²/g.

4. The powder as claimed in claim 1, wherein the powder has a water content of at most 5 wt %.

5. The powder as claimed in claim 1, wherein the lithium ion-conducting material comprises an oxidic material.

6. The powder as claimed in claim 1, wherein the lithium ion-conducting material comprises lithium lanthanum zirconate (LLZO), NaSICon, garnet-like crystal phases and/or lithium aluminum titanium phosphate (LATP).

7. A lithium-ion conductor comprising:
a powder with particulates of a lithium ion-conducting material having a conductivity of at least 10⁻⁵ S/cm,
wherein the powder has an inorganic carbon content (Total Inorganic Carbon Content (TIC)) of less than 0.4 wt % and/or an organic carbon content (Total Organic Carbon Content (TOC)) of less than 0.1 wt %,
wherein particulates have a d50 particle size in a range from 0.05 μm to 10 μm, and
wherein the particulates have a particle size distribution log (d90/d10) of less than 4.

8. A method for lithium-ion conduction, the method comprising:
a) providing a lithium-ion conductor comprising:
a powder with particulates of a lithium ion-conducting material having a conductivity of at least 10-5 S/cm,
wherein the powder has an inorganic carbon content (Total Inorganic Carbon Content (TIC)) of less than 0.4 wt % and/or an organic carbon content (Total Organic Carbon Content (TOC)) of less than 0.1 wt %,
wherein particulates have a d50 particle size in a range from 0.05 μm to 10 μm, and
wherein the particulates have a particle size distribution log (d90/d10) of less than 4, and
b) inserting the lithium-ion conductor in a separator, an anode, a cathode, a primary battery and/or a secondary cell.

9. A method for producing a powder with particulates of a lithium ion-conducting material having a conductivity of at least 10⁻⁵ S/cm, wherein the powder has an inorganic carbon content (Total Inorganic Carbon Content (TIC)) of less than 0.4 wt % and/or an organic carbon content (Total Organic Carbon Content (TOC)) of less than 0.1 wt %, wherein particulates have a d50 particle size in a range from 0.05 μm to 10 μm, and wherein the particulates have a particle size distribution log (d90/d10) of less than 4a powder as claimed in claim 1, the method comprising:
a) providing a crude product by means of a hot operation which comprises temperatures of at least 900° C., and
b) comminuting the crude product with exclusion of CO₂ sources and/or with exclusion of organic carbon sources.

10. The method as claimed in claim 9, wherein the hot operation is selected from the group consisting of (i) melt, (ii) reactive sintering, (iii) calcining of sol-gel precursors, and (iv) bottom-up synthesis in a pulsation reactor.

11. The method as claimed in claim 9, wherein b) comprises one or more of:
b1) comminution by a hammer and chisel,
b2) comminution by jaw crusher, ball mills and/or hammer mills,
b3) comminution by ball, impact and/or planetary mills,
b4) comminution by opposed-jet mills operated with process gases or steam, dry and/or wet ball mills, dry and/or wet agitator ball mills and/or by high-energy grinding in high-kinetic-energy rotor ball mills.
